(19) United States
(12) Patent Application Publication
(10) Pub. No.: US 2013/0275162 A1
(43) Pub. Date: Oct. 17, 2013

(54) MULTI-PARTY TRANSACTION SYSTEM WITH COLLECTIVE RESERVATIONS

(71) Applicant: INDICO INTERACTIVE, INC., San Francisco, CA (US)

(72) Inventors: Michael N. CHAMPLIN, San Francisco, CA (US); David G. CHAMPLIN, San Francisco, CA (US)

(73) Assignee: Indico Interactive, Inc., San Francisco, CA (US)

(21) Appl. No.: 13/856,367

(22) Filed: Apr. 3, 2013

Related U.S. Application Data
(60) Provisional application No. 61/623,474, filed on Apr. 12, 2012.

(51) Int. Cl. G06Q 10/02

(52) U.S. Cl. CPC G06Q 10/02
USPC 705/5

(57) ABSTRACT

Embodiments consistent with the present invention enable multiple users to collectively make reservations for goods or services. One embodiment relates to a method of performing a collective reservation of one or more goods or services by a set of multiple users who are members of a communication context. The communication context may be established by the set of multiple users using instances of a client software application on electronic computing devices and a collective-reservation server. Reservations may be created for multiple sets of items by the multiple users. The reservations may be modified by the multiple users, and the items under a reservation may be purchased by the multiple users. Other embodiments, aspects and features are also disclosed.

### CROSS-REFERENCE TO RELATED APPLICATION(S)

The present application claims the benefit of U.S. Provisional Patent Application No. 61/623,474, filed Apr. 12, 2012, the disclosure of which is hereby incorporated by reference.

### BACKGROUND

1. Technical Field

The present invention relates to electronic commerce and mobile communications.

2. Description of the Background Art

People are increasingly shopping online, including via mobile devices and tablet computers, as well as shopping virtually and later visiting a physical store to pick-up items that were purchased previously online. Hence, on-line retail sales continue to increase.

In another growing trend, mobile communication devices, such as smart phones, are increasingly being used for electronic commerce. For example, people shopping in physical stores are communicating via mobile devices with remote friends to discuss the items they are considering purchasing, to gather second opinions, and to confirm instructions and preferences.

### BRIEF DESCRIPTION OF THE DRAWINGS

FIG. 1 illustrates an arrangement of components for a multi-party transaction system that may be used to provide a collective-reservation experience between two or more users and a business in accordance with an embodiment of the invention.

FIG. 2 shows components of a collective-reservation server in accordance with an embodiment of the invention.

FIG. 3 is a flow diagram that illustrates the steps of a process for performing a shared or collective reservation in accordance with an embodiment of the invention.

FIG. 4 depicts an example computer apparatus for use in implementing system components in accordance with an embodiment of the invention.

### SUMMARY

Embodiments consistent with the present invention enable multiple users to collectively make reservations for goods or services.

One embodiment relates to a method of performing a collective reservation of one or more goods or services by a set of multiple users who are members of a communication context. The communication context may be established by the set of multiple users using instances of a client software application on electronic computing devices and a collective-reservation server. Reservations may be created for multiple sets of items by the multiple users. The reservations may be modified by the multiple users, and the items under a reservation may be purchased by the multiple users.

Another embodiment relates to a collective-reservation server including at least one processor, a tangible, non-transitory data storage system including memory, a communication system for interconnecting the at least one processor and the data storage system, and a network interface for communicating with a data network. The server includes computer-readable program code stored in the data storage system for (a) establishing the communication context by the set of multiple users, (b) creating reservations for multiple sets of items by the multiple users, (c) providing for modification of the reservations by the multiple users, and (d) providing for purchase of items in a set of items under one reservation by the multiple users.

Another embodiment relates to a system for performing a collective reservation of one or more goods or services by a set of multiple users who are members of a communication context. The system includes a collective-reservation server and a plurality of mobile communication devices executing instances of a client software application.

Other embodiments, aspects and feature are also disclosed.

### DETAILED DESCRIPTION

People often coordinate and conduct transactions together as a group, like purchasing a set of seats to an upcoming rock concert or reserving a cabin to share during a ski trip. These coordinated transactions often involve communication, perhaps as an exchange of SMS text messages, an email thread, or an instant message conversation, as options are considered and details are discussed.

However, the interfaces that businesses provide today for conducting transactions like buying tickets or reserving vacation rentals are designed to enable a single user to make a transaction. While three users may be discussing seating options for the upcoming rock concert and independently interacting with the business' web experiences to find tickets, the business' server systems have no way to associate the independent visits from the three customers. As a result, the only way for the three users to ensure they reserve three adjacent seats is for one of the three users to buy all three tickets at once in a single transaction. The other participants cannot buy their own seats and instead will have to reimburse the purchaser.

Applicants believe that, as the worlds of communication, mobile commerce, and online shopping intersect, users would benefit from an ability to collaboratively reserve one or more items. Applicants have determined that conventional electronic commerce and mobile communications systems are lacking in support for making such a shared or collective reservation. The present application discloses a system and method for performing a collective reservation where the reservation of one or more items is jointly made by more than one identified person.

In accordance with an embodiment of the invention, the system disclosed herein associates one or more reservations for one or more items or services with a set of multiple users. The set of multiple users may have a shared communication context, and membership in the shared communication context may be used to determine if a particular user is authorized to adjust the reservations. Modification to one of the reservations may be used to affect other reservations.

In accordance with an embodiment of the invention, the users may participate in creating and modifying one or more shared reservations by utilizing electronic computer interfaces. The electronic computer interfaces may be rendered on a variety of computing devices, including mobile devices such as smart phones and tablet computers.

In accordance with an embodiment of the invention, a business or other entity may use knowledge of the set of participants in a communication context to manage the reservation and release of inventory. For example, in a ticket reservation and purchase case, the business may reserve sets of tickets as participants suggest various seating and/or time options to the rest of the group. When the group makes a decision, committing to one group of seats and/or tickets, the business may release all other temporarily reserved ticket inventory that the group was discussing. Additionally, by associating reservations with the group's communication context instead of with individual participants, it is easy to modify reservations as the roster of participants changes.

Advantageously, in accordance with an embodiment of the invention, a business may provide a superior experience for coordinated transactions by joining in communication about a business activity, like buying tickets to a rock concert. For instance, a user may be experiencing the concert venue's web site, and, from the context of this web site, begin conversing with a couple of friends about attending a concert together. Once the business becomes aware of the communication session that is coupled with the ticket purchase activity, the business may customize the interfaces that each user experiences to be appropriate for a group purchase. The business may then showcase groups of three adjacent seats, enable the reservation of multiple blocks of seats, and support each individual purchasing his own ticket as part of a larger group transaction.

In the context of the present application, a “business activity” may be defined as an experience designed by the business, that leads to an outcome or accomplishment that is valuable for the business.

In the context of the present application, an “interactive interface” may be defined as a collection of software and media resources which, when rendered, shows information to the user and may present the user with one or more user interface controls. When selected, the user interface controls may communicate with local or remote systems and communicate their selection and additional information provided by the user. For example, an interactive interface may enable a user to make a selection of one or more reservable seats for an upcoming rock concert. In an exemplary implementation, the user's selection may be communicated from a mobile communication device executing the interactive interface to a collective-reservation server over the Internet.

In the context of the present application, a “communication context” may be defined as a group of entities associated with a facility for communication. The associated entities are often people (i.e. accounts of identified end users), but could possibly include computerized or machine agents. Communication may include various forms of exchange of information over a network. Examples include, but are not limited to, SMS and MMS messaging, email, instant messaging, social network posting, social network messaging, document or media collaboration, or voice or video conversation. In this definition, the exchanges of information could be real-time or asynchronous.

In other words, a communication context associates a set of users with a set of exchanged messages. In one implementation, a datastore would have a record that describes the communication context. This record includes, among other things, an ID that uniquely identifies the communication context. The set of participants in the communication context might be represented by a collection of records, each of which associates the ID of the communication context and the ID of a user. Additionally, the set of exchanged messages in the communication context might be represented by a collection of records, each of which associates the ID of the communication context with the ID of a message.

The members of the communication context may be established in various ways depending on the implementation. Membership may be defined by specifying a group or by adding members individually. In the case of specifying a group, a group may be specified with an initial member identified with a user ID, and members may be added to a group by adding their user IDs to a membership list. Note that it is possible that a group may be specified that has zero initial members, members being added to the group in the future. As an example of such a group, it is possible that a communication context may be established for the set of users who will occupy a particular conference room at a future time, but that the attendee roster is unknown at the present time. In another case of specifying the members via a group, the group may be an ad hoc group. Examples of ad hoc groups include those that are formed by the members sharing the current location, the members associating their devices together via near field communication, or detecting a shared signal of some form. The set of members of a communication context may vary over time as users are added and removed from the set.

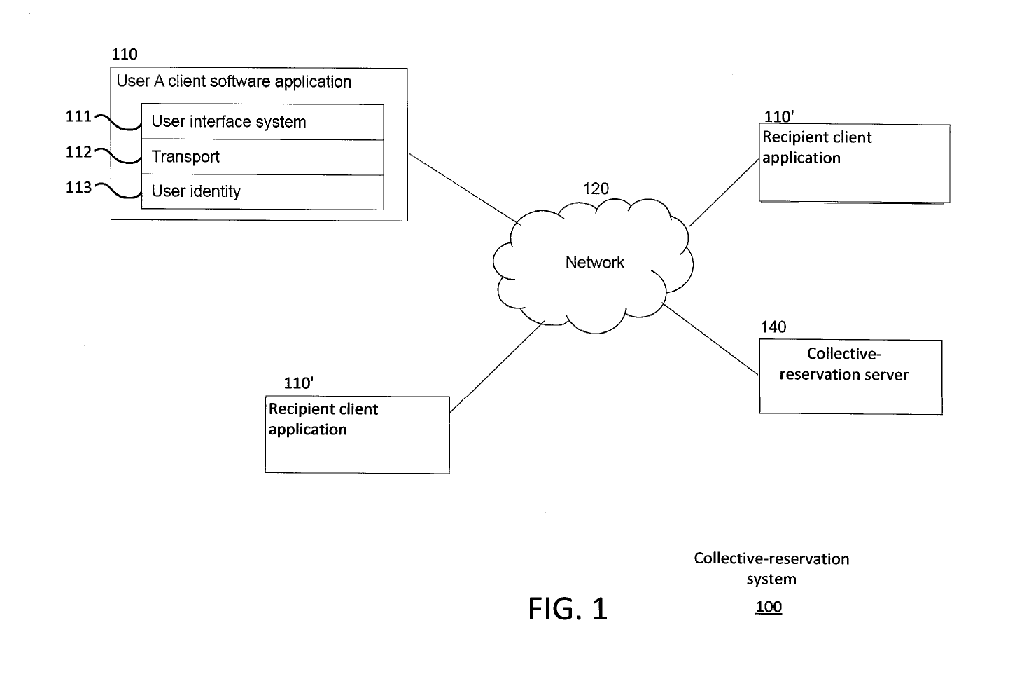

FIG. 1 illustrates an arrangement of components for a collective-reservation system (100) that may be used to provide a reservation experience shared by two or more users and a business in accordance with an embodiment of the invention. Each user has a computer, which may be a mobile computing device, such as a smart phone.

The user who begins the business activity may run a client software application (110) on his/her computer device. The client software application may be implemented as web pages and scripts rendered in a browser. The client software application may alternatively be implemented as a native application. The client software application may be used on a variety of computer systems, like a smartphone, a tablet computer, a laptop or other computer, an Internet-connected television, a video game console, etc.

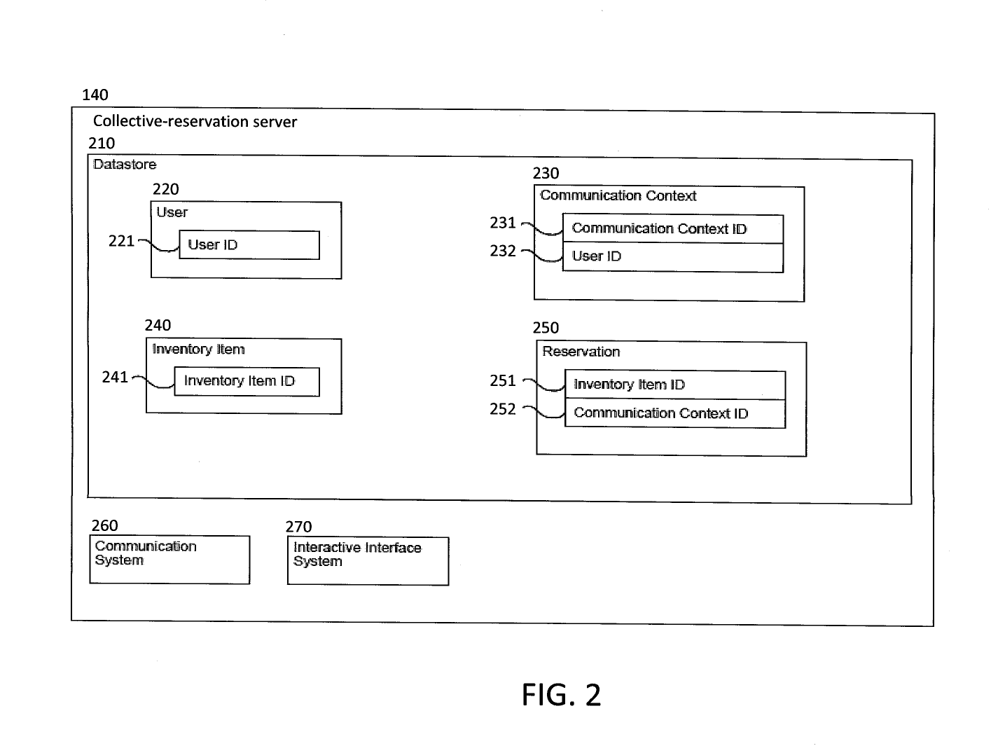

In one implementation, the client software application implements a user interface system (111) that is capable of rendering user interfaces to the user and of accepting and processing user input. The client software application implements a transport (112) that can communicate with the collective-reservation server (140), which is described in more detail in FIG. 2, over a network (120), such as the Internet, using one or more protocols, such as TCP/IP, HTTP, HTTPS, XMPP, etc. The transport can authenticate the collective-reservation server using a variety of methods, such as the authentication methods defined in the Transport Layer Security protocol. The client software application also hosts the identity (113) of its user and can provide this to the collective-reservation server.

Other participants run recipient client software applications (110′) on their computers. Each recipient client software application (110′) may have the same components (111, 112, and 113) as the client software application (110). In one implementation, the client software application (110) and the recipient client software application (110′) may be instances of the same application. Alternatively, they may be different applications, each having the depicted components (111, 112, and 113).

As described herein, the system (100) of FIG. 1 may be used within electronic commerce systems. The system (100) enables multiple customers to coordinate purchases of related items that may be relatively scarce. For example, if a group of four people are trying to purchase tickets in independent transactions to the same movie, the theater might find it useful to temporarily reserve the tickets they have selected. This ensures that all four tickets will remain available while the participants complete their transactions. Associating the reserved movie tickets with a communication context enables the theater to manage the reservation efficiently. The system may also be used when enabling groups of people to reserve and independently purchase seats next to each other on a train or a plane, or at a concert or sports event.

FIG. 2 shows components of a collective-reservation server (140) in accordance with an embodiment of the invention. In the implementation depicted in FIG. 2, the collective-reservation server (140) includes a communication system (260) that enables users to exchange messages with each other via interfaces in the client software applications. In other implementations, the communication system associated with the client software applications might exist outside of the collective-reservation server. The associated communication system might be SMS/MMS, or an instant messaging system, or a social network platform, or email, or a voice or video connection among the users, or combinations of communication systems.

The collective-reservation server (140) may further include an interactive interface system (270) that generates, stores, delivers, and manages user interfaces that can be utilized by software client applications. In one implementation, the interactive interface system is used to present user interfaces that enable users to engage in the business activity, such as selecting items for purchase.

The collective-reservation server (140) may further include a datastore (210) that stores various records. These records may include user record data (220), communication context data (230), inventory item data (240), and reservation data (250). The stored records and their use are described further below.

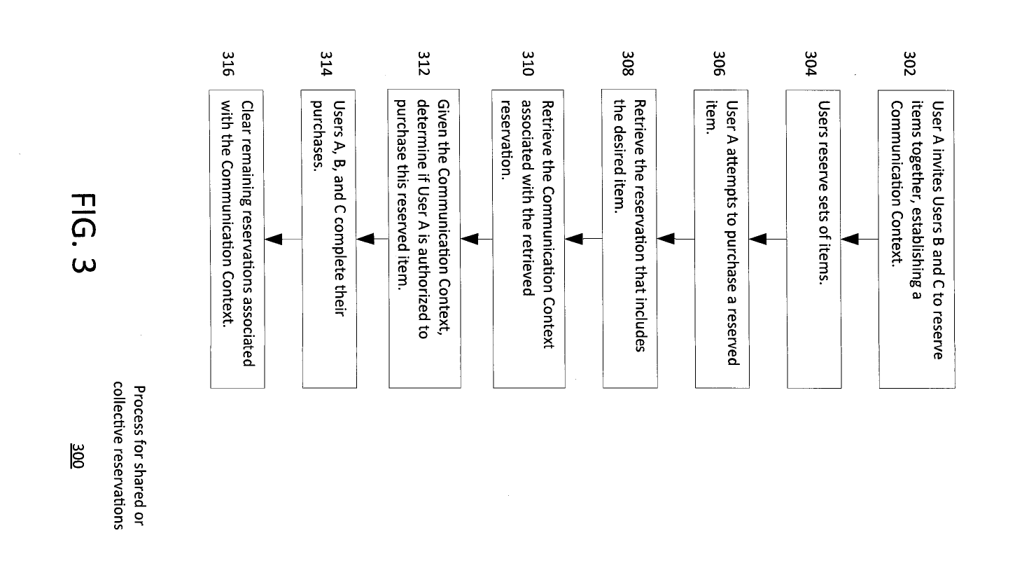

FIG. 3 is a flow diagram that illustrates the steps of an exemplary process (300) for performing a shared or collective reservation in accordance with an embodiment of the invention. In this process, a reserved inventory of goods or services may be associated with a communication context shared by multiple participants. As disclosed herein, associating the reserved inventory with the communication context supports coordinated reservations from multiple customers using separate interfaces.

In this exemplary process, consider that a group of friends, users A, B, and C in this example, would like to coordinate the purchase of train tickets so that they can travel later this afternoon from London to Cambridge. While there are three users in this example, the number of users may be, in general, two or more.

Further, suppose that each user in the group is using a client software application that provides both a communication interface and an interactive interface, where the interactive interface enables each user to search for, reserve and separately purchase train tickets. The users may search the train schedule for available tickets and share results with each other. In this example, the shared results may describe train departure and arrival locations and times, seat assignments, and pricing information.

The users A, B, and C may be using a client software application (110 and 110′) affiliated, in this example, with the transportation agency or business that runs the train between London and Cambridge. The client software application may include transport software (112) that enables it to communicate over the Internet with the collective-reservation server (140), and to display interactive interfaces to the user and respond to user actions using a user interface system (111).

User A may communicate with one or more other participants, users B and C in this example, using the client software application (110) and the collective-reservation server (140). In one implementation, the client software application (110) presents a user interface control to user A that helps the user begin a business activity, such as inviting users B and C to make a reservation together. Users B and C need not be in the same location as user A. Users B and C may also use the client software applications (110′).

Per step (302), the participants may begin the activity and establish a shared Communication Context. The collective-reservation server (140) may represent each participant by a user identifier (ID) (221) associated with a user record in the user record data (220) in the datastore (210). The collective-reservation server (140) may also associate each participant's user ID (232) with a shared communication context ID (231) in one or more communication context records in the communication context data (230). In one implementation, a communication context record may associate a group of one or more user IDs with a communication context ID. This implementation is depicted in FIG. 2. In an alternate implementation, a separate record may be provided for each user, and each such user record may associate the communication context ID with a single user ID. In either implementation, the resulting set of records fully describes the relationship of the participant users to the communication context.

The establishment of the communication context may include creating a new communication context or utilizing a pre-existing communication context. For example, User A may select a communication context that includes a long-running communication thread among Users A, B, and C. Note that a communication context may be established not by an initial user reaching out to other users, but through alternate means. In one alternate example, an agent of the business may simultaneously send notifications to Users A, B, and C, pulling each user into a shared communication context.

Per block (304), the users may reserve a set of items. In this example, the multiple users may search for train times from a station in London to a station in Cambridge. As they find train times that interest them, they may add interactive interfaces that describe the train times to their shared communication context.

Furthermore, in one embodiment, when a user adds an interactive interface that describes a set of tickets for a particular train to the “conversation” (i.e., to the shared communication context), the system may make a reservation for that set of tickets. The reservation may be accomplished by the collective-reservation server (140) generating, in the reservation data (250), one or more reservation records which associate inventory item IDs (251) with the communication context ID (252). In one implementation, a reservation record may associate a group of one or more inventory item IDs with a communication context ID. This implementation is depicted in FIG. 2. In an alternate implementation, a separate record may be provided for each inventory item, and each such item record may associate the communication context ID with a single inventory item.

At some point, the participant users may choose the set of items (for example, train tickets) that they wish to purchase and so go forward and execute their transactions. When a participant user (for instance, User A in the example above) attempts to purchase a reserved item per block (306), the collective-reservation server (140) may authorize the user's action by performing a sequence of steps. First, per block (308), the collective-reservation server (140) may retrieve the reservation record that includes the inventory item ID (251) of the reserved item. Second, per block (310), the collective-reservation server (140) extracts the communication context ID (231) from the retrieved reservation record (250). Third, per block (312), the collective reservation server (140) examines the mapping of users to communication contexts (230) and authorizes User A's action if a record exists that associates User A's ID (232) with the ID of the retrieved communication context (231). This enables User A to purchase an item reserved by a different member in the same communication context (for example, User A can purchase a seat in a set of seats originally reserved by User B).

Similar to User A purchasing reserved items as described above in relation to blocks (306) through (312), Users B and C may also perform their purchases of reserved items associated with the same communication context ID. Once the purchases have been made, Users A, B and C may, per block (314), complete their purchases of reserved items associated with the communication context ID. Thereafter, once the purchases are completed, the remaining (temporary) reservation records associated with the communication context ID may be found and then cleared per block (316).

Note that the above-described collective reservation may be temporary in that it may be cancelled and/or may expire, and multiple temporary reservations may be made for different contemplated sets of tickets. In our example, the collective-reservation server (140) may need to temporarily reserve specified tickets and seat assignments as the users discuss them so that the tickets and seats will be available when the customers try to purchase them.

For instance, if User A suggests the 2:15 pm train and User B suggests the 3:05 pm train, the collective-reservation server (140) may temporarily reserve tickets for both trains for the group (for example, by creating reservation records associating the inventory item IDs of the temporarily reserved tickets with the communication context ID). When the group eventually decides to purchase tickets for the 3:05 pm train, then the collective-reservation server (140) may release the un-bought tickets for the 2:15 pm train (for example, by deleting the reservation records for those tickets) so that they are available for purchase by other customers.

Thus, in accordance with an embodiment of the invention, the collective-reservation server (140) associates a business activity with a communication context and its participants. In the scenario introduced above, the collective-reservation server (140) associates temporary reservations for the 2:15 pm train and for the 3:05 pm train with the communication context. With such associations being made, any member of the communication context may then have access to the reserved tickets. Once the group purchases tickets for the 3:05 train, for instance, then the other temporary reservations associated with the communication context may be released by deleting the reservation records.

In the above discussion, the collective-reservation server (140) associates an inventory reservation with a communication context. However, an alternate embodiment may instead associate an inventory reservation with an explicit list of user identifiers. In this embodiment, if the communication context membership fluctuates, the list of user identifiers may be adjusted to match the membership.

In another alternate embodiment, the collective-reservation server (140) may establish a session at the beginning of the execution of the business activity. In this case, a particular instance of the business activity (identified by the session) may be associated with the communication context. The collective-reservation server (140) may then map an inventory reservation to the session's unique identifier.

In the above-described system and method, every reservation is represented as an association between a reservation ID and the ID of a communication context. In order to enable a user to access, modify, or purchase something that is reserved, the system looks for the communication context associated with the reservation and then authorizes the action if the user is a member of the communication context.

In contrast, conventional reservation systems do not associate reservations with communication contexts and do not determine authorization to records based on users' membership in communication contexts. Existing systems might associate a reservation directly with a set of user IDs or with a group of users, but this mapping is not established through an association with a communication context in which messages are exchanged among the users.

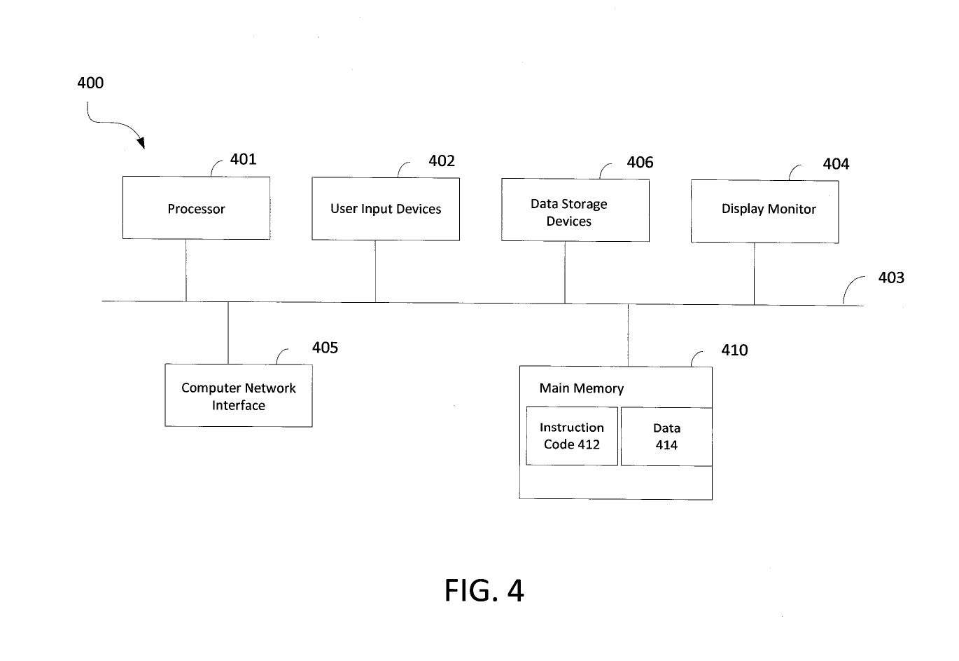

FIG. 4 depicts a simplified example of a computer apparatus (400) in accordance with an embodiment of the invention. This figure shows just one simplified example of such a computer apparatus. A computer apparatus (400) having the illustrated components may be utilized, for example, as client computing devices for executing client computer software applications (110 and/or 110′), as a server computer for use as a collective-reservation server (140).

As shown, the computer apparatus (400) may include one or more processors (401), such as those from the Intel Corporation of Santa Clara, Calif., for example. The computer apparatus 400 may have one or more buses (403) communicatively interconnecting its various components. The computer apparatus (400) may include one or more user input devices 402 (e.g., keyboard, mouse, etc.), a display monitor (404) (e.g., liquid crystal display, flat panel monitor, etc.), a computer network interface (405) (e.g., network adapter, modem), and a data storage system that may include one or more data storage devices (406) which may store data on a hard drive, semiconductor-based memory, optical disk, or other tangible non-transitory computer-readable storage media, and a main memory (410) which may be implemented using random access memory, for example.

In the example shown in this figure, the main memory (410) includes instruction code (412) and data (414). The instruction code (412) may comprise executable computer-readable program code (i.e., software) components which may be loaded from the tangible non-transitory computer-readable medium of the data storage device (406) to the main memory (410) for execution by the processor(s) (401). In particular, the instruction code (412) may be programmed to cause the computer apparatus (400) to perform the steps described herein.

The above-described diagrams are not necessarily to scale and are intended be illustrative and not limiting to a particular implementation. In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of performing a collective reservation of one or more goods or services by a set of multiple users who are members of a communication context, the method comprising:
establishing the communication context by the set of multiple users using instances of a client software application on electronic computing devices and a collective-reservation server;
creating a reservation for a set of one or more items by the multiple users of the communication context using interactions between the instances of the client software applications and the collective-reservation server;
providing for modification of the reservation by the multiple users using interactions between the instances of the client software applications and the collective-reservation server; and
providing for purchase of the one or more items in the set by the multiple users using interactions between the instances of the client software applications and the collective-reservation server.

2. The method of claim 1, wherein establishing the communication context comprises:
generating and storing records in a datastore for the collective-reservation server, wherein the records associate the communication context with identifiers of the multiple users in the communication context.

3. The method of claim 1 wherein creating a reservation comprises:
generating and storing records in a datastore for the collective-reservation server, wherein the records associate the communication context with at least one identifier for an item.

4. The method of claim 1, wherein providing for modification of the reservation by a user comprises:
determining whether a user identifier is associated with the communication context identifier associated with the reservation; and
authorizing the modification if the user identifier is associated with the communication context identifier.

5. The method of claim 1, wherein providing for purchase of one or more items in the set of items under the reservation by a user comprises:
determining whether a user identifier is associated with the communication context identifier associated with the reservation; and
authorizing the purchase if the user identifier is associated with the communication context identifier.

6. The method of claim 1, wherein the electronic computing devices include mobile devices.

7. The method of claim 1, wherein the items comprise tickets.

8. A collective-reservation server comprising:
at least one processor;
a tangible, non-transitory data storage system including memory;
a communication system for interconnecting the at least one processor and the data storage system;
a network interface for communicating with a data network;
computer-readable program code stored in the data storage system for
establishing the communication context by the set of multiple users using instances of a client software application on electronic computing devices and the collective-reservation server;
creating a reservation for a set of one or more items by the multiple users of the communication context using interactions between the instances of the client software applications and the collective-reservation server;
providing for modification of the reservation by the multiple users using interactions between the instances of the client software applications and the collective-reservation server; and
providing for purchase of the one or more items in the set by the multiple users using interactions between the instances of the client software applications and the collective-reservation server.

9. The collective-reservation server of claim 8, wherein establishing the communication context comprises:
generating and storing records in a datastore for the collective-reservation server, wherein the records associate the communication context with identifiers of the multiple users in the communication context.

10. The collective-reservation server of claim 8, wherein creating a reservation comprises:
generating and storing records in the datastore, wherein the records associate the communication context with at least one identifier for an item.

11. The collective-reservation server of claim 8, wherein providing for modification of the reservation by a user comprises:
determining whether a user identifier is associated with the communication context identifier associated with the reservation; and
authorizing the modification if the user identifier is associated with the communication context identifier.

12. The collective-reservation server of claim 8, wherein providing for purchase of one or more items in the set of items under the reservation by a user comprises:
determining whether a user identifier is associated with the communication context identifier associated with the reservation; and
authorizing the purchase if the user identifier is associated with the communication context identifier.

13. A system for performing a collective reservation of one or more goods or services by a set of multiple users who are members of a communication context, the system comprising:
a plurality of mobile communication devices executing instances of a client software application; and
a collective-reservation server for communicating with the instance of the client software application by way of a data communications network, the server comprising
at least one processor,
a tangible, non-transitory data storage system including memory,
a communication system for interconnecting the at least one processor and the data storage system,
a network interface for communicating with the data communication network,
computer-readable program code stored in the data storage system for
establishing the communication context by the set of multiple users using instances of the client software application on the electronic computing devices and the collective-reservation server;
creating a reservation for a set of one or more items by the multiple users of the communication context using interactions between the instances of the client software applications and the collective-reservation server;
providing for modification of the reservation by the multiple users using interactions between the instances of the client software applications and the collective-reservation server; and
providing for purchase of the one or more items in the set by the multiple users using interactions between the instances of the client software applications and the collective-reservation server.

14. The system of claim 13, wherein establishing the communication context comprises:
generating and storing records in a datastore for the collective-reservation server, wherein the records associate the communication context with identifiers of the multiple users in the communication context.

15. The system of claim 13, wherein creating a reservation comprises:
generating and storing records in the datastore, wherein the records associate the communication context with at least one identifier for an item.

16. The system of claim 13, wherein providing for modification of the reservation by a user comprises:
determining whether a user identifier is associated with the communication context identifier associated with the reservation; and
authorizing the modification if the user identifier is associated with the communication context identifier.

17. The system of claim 13, wherein providing for purchase of one or more items in the set of items under the reservation by a user comprises:
determining whether a user identifier is associated with the communication context identifier associated with the reservation; and
authorizing the purchase if the user identifier is associated with the communication context identifier.
